(19) United States
(12) Patent Application Publication
(10) Pub. No.: US 2013/0197922 A1
(43) Pub. Date: Aug. 1, 2013

(54) METHOD AND SYSTEM FOR DISCOVERY AND CONTINUOUS IMPROVEMENT OF CLINICAL PATHWAYS

(71) Applicant: Guy Robert Vesto, Barrington, IL (US)

(72) Inventor: Guy Robert Vesto, Barrington, IL (US)

(21) Appl. No.: 13/362,075

(22) Filed: Jan. 31, 2012

(51) Int. Cl. G06Q 50/22

(52) U.S. Cl. 705/2

(57) ABSTRACT

Systems, apparatus and methods are provided. An example method includes gathering healthcare data and analyzing care paths currently in use by a healthcare organization, the analyzing including analyzing patterns and variances with respect to the care paths; defining one or more evidence-based clinical pathways based on the gathered healthcare data and analyzed care paths in conjunction with practitioner review and supporting metrics; facilitating implementation of the defined one or more evidence-based clinical pathways using computerized orders, computer-facilitated workflows and clinical dashboards; tracking usage of the one or more evidence-based clinical pathways and providing reminders to users to encourage compliance; monitoring deviations from the one or more evidence-based clinical pathways; accepting feedback from at least one of patients and practitioners; and analyzing deviations and feedback with respect to the one or more evidence-based clinical pathways to determine modification of the one or more evidence-based clinical pathways.

### FIELD

The present invention generally relates to clinical pathways. More specifically, the present invention relates to systems, methods, and apparatus for learning, use and improvement of clinical pathways.

### BACKGROUND

Today's healthcare involves electronic data and records management. Information systems in healthcare include, for example, healthcare information systems (HIS), radiology information systems (RIS), clinical information systems (CIS), and cardiovascular information systems (CVIS), and storage systems, such as picture archiving and communication systems (PACS), library information systems (LIS), and electronic medical records (EMR). Information stored may include patient medical histories, imaging data, test results, diagnosis information, management information, and/or scheduling information, for example. The content for a particular information system may be centrally stored or divided at a plurality of locations. Healthcare practitioners may desire to access patient information or other information at various points in a healthcare workflow. Availability of data also provides opportunities for healthcare analytics.

Nearly all Americans are cared for by business models that profit from patients' sickness rather than wellness. This has trapped care in high cost business models. Few patients are searching to “hire” healthcare providers that can do everything for everyone else. Generally, after diagnosis most patients want the medical problem fixed as effectively, affordable and conveniently as possible. Variation is a critical element in health care systems today. Quality problems are reflected in a wide variation in the use of health care services, underuse of some services, overuse of other services, and misuse of services, and an unacceptable level of errors.

In particular, professional uncertainty and scarce use of medical evidence seem to be the key elements in many problems dealing with healthcare variations. According to an investigation by Hearst Corporation, a staggering number of Americans will die (the estimated number was 200,000 in 2009) needlessly from preventable mistakes and infections every year. Even if it is difficult to establish a direct relationship between variations and errors, reducing variations by standardizing clinical processes is an effective tool to minimize the probability of medical errors. According to the Oxfords Journal, variation problems are especially critical today because the pressure to reduce healthcare costs without reducing quality in patient care has increased.

### BRIEF SUMMARY

Certain examples provide systems, methods, and apparatus for clinical pathway analytics and support.

Certain examples provide a computer-implemented method including gathering healthcare data and analyzing care paths currently in use by a healthcare organization, the analyzing including analyzing patterns and variances with respect to the care paths. The example method includes defining, using a processor, one or more evidence-based clinical pathways based on the gathered healthcare data and analyzed care paths in conjunction with practitioner review and supporting metrics. The example method includes facilitating implementation of the defined one or more evidence-based clinical pathways using computerized orders, computer-facilitated workflows and clinical dashboards. The example method includes tracking, using a processor, usage of the one or more evidence-based clinical pathways and providing reminders to users to encourage compliance. The example method includes monitoring deviations from the one or more evidence-based clinical pathways. The example method includes accepting feedback from at least one of patients and practitioners. The example method includes analyzing deviations and feedback with respect to the one or more evidence-based clinical pathways to determine modification of the one or more evidence-based clinical pathways.

Certain examples provide a tangible computer-readable storage medium including a set of instructions to be executed by a processor, the instructions, when executed, implementing a method. The example method includes gathering healthcare data and analyzing care paths currently in use by a healthcare organization, the analyzing including analyzing patterns and variances with respect to the care paths. The example method includes defining, using a processor, one or more evidence-based clinical pathways based on the gathered healthcare data and analyzed care paths in conjunction with practitioner review and supporting metrics. The example method includes facilitating implementation of the defined one or more evidence-based clinical pathways using computerized orders, computer-facilitated workflows and clinical dashboards. The example method includes tracking, using a processor, usage of the one or more evidence-based clinical pathways and providing reminders to users to encourage compliance. The example method includes monitoring deviations from the one or more evidence-based clinical pathways. The example method includes accepting feedback from at least one of patients and practitioners. The example method includes analyzing deviations and feedback with respect to the one or more evidence-based clinical pathways to determine modification of the one or more evidence-based clinical pathways.

Certain examples provide a system including a data ingestor to gather healthcare data and analyze care paths currently in use by a healthcare organization, the data ingestor using a correlator to analyze patterns and variances with respect to the care paths. The example system includes a graph database to define, using a processor, one or more evidence-based clinical pathways based on the gathered healthcare data and analyzed care paths in conjunction with practitioner review and supporting metrics. The data ingestor and graph database are to facilitate implementation of the defined one or more evidence-based clinical pathways using computerized orders, computer-facilitated workflows and clinical dashboards. The example system includes a care path navigator to track usage of the one or more evidence-based clinical pathways and provide reminders to users to encourage compliance. The example system is to monitor deviations from the one or more evidence-based clinical pathways, accept feedback from at least one of patients and practitioners, and analyze deviations and feedback with respect to the one or more evidence-based clinical pathways to determine modification of the one or more evidence-based clinical pathways.

### BRIEF DESCRIPTION OF SEVERAL VIEWS OF THE DRAWINGS

FIG. 1 illustrates example pathways on a map to get from one state to another.

FIG. 2 depicts a flow diagram for an example method for discovery and continuous improvement of clinical pathways.

FIG. 3 illustrates an example system to provide collective intelligence across multiple clinical pathway implementers.

FIG. 4 shows an example graph representing one instance of an episode of care.

FIG. 5 illustrates an example data model including multiple connected graphs.

FIG. 6 is a block diagram of an example processor platform capable of implementing methods, systems, apparatus, etc., described herein.

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION OF CERTAIN EXAMPLES

The creation of clinical pathways has become a popular response to these concerns. Clinical pathways (also known as critical pathways, care maps, integrated care pathways, etc.) are integrated management plans that display goals for patients, and provide the sequence and timing of actions necessary to achieve such goals with optimal efficiency. Clinical pathways stress the improvement of clinical processes in order to improve clinical effectiveness and efficiency. A clinical pathway is a multidisciplinary management tool based on evidence-based practice for a specific group of patients with a predictable clinical course, in which the different tasks (e.g., interventions) by professionals involved in patient care are defined, improved/optimized and sequenced by hour (e.g., for emergency department (ED)), day (e.g., acute care) or visit (e.g., homecare). Outcomes are tied to specific interventions, for example.

One or more indicators can be analyzed to determine that it may be useful to commit resources to establish and implement a clinical pathway for a particular condition. Example indicators can include prevalent pathology within the care setting, pathology with a significant risk for patients, pathology with a high cost for the hospital, predictable clinical course, pathology well defined and that permits a homogeneous care, existence of recommendations of good practices or experts opinions, unexplained variability of care, possibility of obtaining professional agreement, multidisciplinary implementation, motivation by professionals to work on a specific condition, etc.

Thus, clinical paths are clinical management tools used by health care workers to define the best process in their organization, using the best procedures and timing, to treat patients with specific diagnoses or conditions according to evidence-based medicine (EBM). As a consequence, the introduction of clinical pathways could be an effective strategy for health care organizations to reduce or at least to control their processes and clinical performance variations.

However, there are a number of challenges with implementing standardized clinical pathways in healthcare organizations. Building and developing clinical pathways may require business re-engineering techniques, involvement of multidisciplinary teams, pre and post analysis models to evaluate the effect of applying standardized pathways to process and outcome indicators.

To help ensure implementation success, patient satisfaction must also be measured along with adoption obstacles faced by care providers. In the past, finding the proper balance between clinician autonomy and standardization has proven difficult. Many doctors still consider clinical pathways as “cookbook medicine”, even though they could change the pathway for a patient at any time. Critics of clinical pathways argue that by discouraging idiosyncrasies in clinical methods, standards introduce disincentives for individual innovations in care and healthy competition among practitioners. Instead of revolutionizing care, evidence based medicine therefore threatens to bring about stagnation and bland uniformity, derogatorily characterized as “cookbook medicine.”

Furthermore, if clinicians are not involved in the definition and continuous improvement of clinical guidelines, there is a real danger that the clinical pathways could be considered an administrative attempt to reduce costs, and therefore it would most likely fail. The implementation tasks may seem daunting at first without expert assistance.

Certain examples provide expert support, analytical services and decision support during an initial clinical care pathways implementation phase and to continuously improve established pathways. Furthermore, certain examples improve upon evidence based medicine and standardized pathways such as “cookbook medicine.”

Although the following discloses example methods, systems, articles of manufacture, and apparatus including, among other components, software executed on hardware, it should be noted that such methods and apparatus are merely illustrative and should not be considered as limiting. For example, it is contemplated that any or all of these hardware and software components could be embodied exclusively in hardware, exclusively in software, exclusively in firmware, or in any combination of hardware, software, and/or firmware. Accordingly, while the following describes example methods, systems, articles of manufacture, and apparatus, the examples provided are not the only way to implement such methods, systems, articles of manufacture, and apparatus.

When any of the appended claims are read to cover a purely software and/or firmware implementation, in an embodiment, at least one of the elements is hereby expressly defined to include a tangible medium such as a memory, DVD, CD, Blu-ray, etc., storing the software and/or firmware.

Certain examples connect consumers (e.g., patients) to advancements in healthcare, such as in molecular medicine and clinical research relevant to their predisposed diseases (e.g., genetically, hereditarily, environmentally, etc., pre-disposed or inclined to suffer from). Furthermore, certain examples provide systems, apparatus, and methods including guidance for a user to seek professional intervention. Certain examples provide a knowledge exchange clearinghouse.

An explosion of available data provides opportunities for “big data” analytics (e.g., Medical Quality Improvement Consortium (MQIC) analytics and/or other clinical decision support). Empowering the consumer and focusing on preventative care and early health can help reduce the overall cost of healthcare.

Furthermore, advancements in molecular medicine bring big data and information sharing challenges. Few have focused on how to distribute new discoveries and learning directly to consumers. Genetic testing has become affordable, but, as consumers are becoming more aware of diseases for which they are predisposed, they will also become more concerned about how to prevent and manage them. The amount of available information relevant to a patient's medical disposition and treatment is growing at a rate with which doctors cannot keep pace. In fact, more medical literature is published annually than a doctor can read in a lifetime. Certain examples identify and analyze these trends and enable knowledge sharing for early health and disease prevention.

Certain examples provide an end-to-end method and machine learning system for continuous learning, innovation, improvement and implementation of clinical pathways. The example system assists healthcare organizations in overcoming technical, social and cultural adoption challenges associated with clinical pathways. The system encourages process compliance and establishes feedback loops with providers and patients. The system learns by tracking and evaluating alternate paths which fosters innovation and prevents clinical pathways from becoming stagnant. The system includes analytics services, real-time actionable intelligence services, reports and dashboards.

Certain examples are described below at various levels of detail: a.) at a conceptual level, b.) at a process level including an example method, c.) at a system level which describes at least certain components and d.) at a data model level.

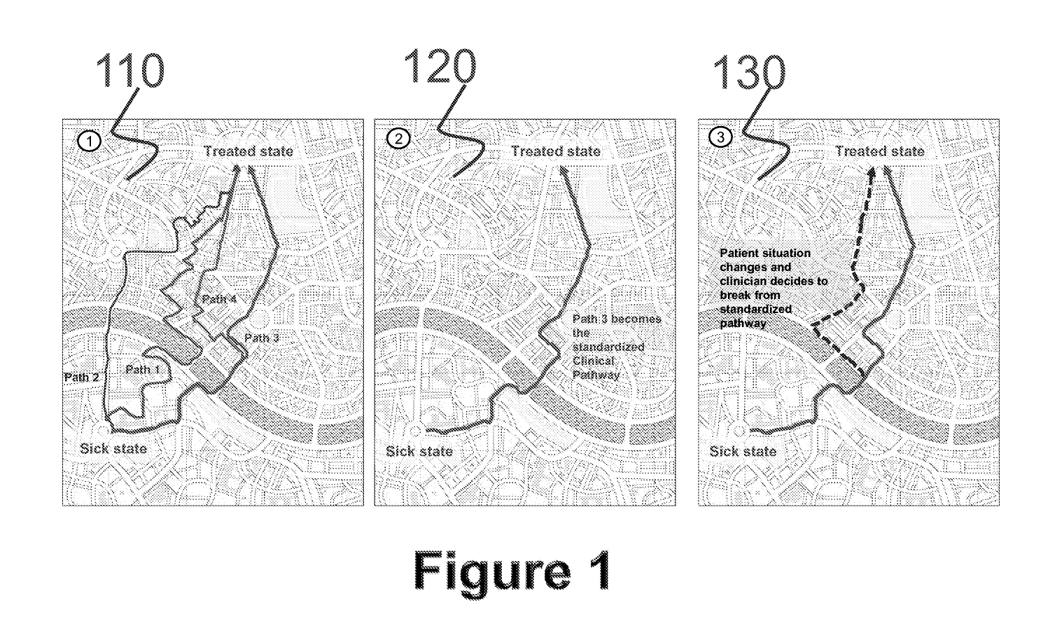

Certain examples include a specialized cloud-based analytics platform and decision support services. These assist healthcare organizations to implement and continuously improve standardized clinical pathways. There are some similarities to GPS-based navigation systems that conceptually help explain certain examples (see FIG. 1).

Analogizing pathways to routes on a map, as shown in FIG. 1, pathways are like transportation companies hired to “transport” patients from the “sick state” to the “treated” state. As shown in the first pane 110 of FIG. 1, a variety of different paths can be taken to reach the goal. Each path comes at a different cost, efficiency and convenience for the patient. There can be many stops and vehicles along the way before reaching the destination, just as many chronically ill patients can receive care from multiple healthcare providers and specialists. Lack of coordination across the fragmented group of providers often exasperates patients and contributes to the staggering cost of care. Certain examples analyze the various care paths healthcare providers take in their day-to-day practice. Certain examples visualize the care paths and analyze the associated cost, efficiency and outcomes. This helps determine an amount of variation in the system and identifies improvement opportunities.

Healthcare organizations may decide to standardize some clinical pathways for common diseases they treat to improve the overall quality of care and reduce cost. At this phase, certain examples assist the standardization process by providing suggestions and guidelines. As with a global positioning system (GPS)-based navigation system in which a shortest or fastest route can be suggested and alternate routes can be provided in case of construction road blocks, etc. (see 120 of FIG. 1), certain examples provide care pathways to achieve one or more objectives for care of a patient.

After standardization, it is still possible that care providers may decide on an alternate path or otherwise deviate from the established clinical pathways (see 130 of FIG. 1). Certain examples continue to track the taken path and may provide hints about possible cost and outcome if previous data exists. A hint may be in form of an informational message to the clinician, for example. For example, a message may include: “A standardized clinical pathway exists. Previous experience shows that the Average Length of Stay for the patient increased by 10 days, Readmission Rate doubled and the Mortality Rate increased when deviating from this pathway.” The purpose of the informational messages is to nudge the care providers to comply with the clinical pathways. However, there may be valid reasons to deviate from the established clinical pathways. For example, there might be new treatment methods available; the patient may want to participate in a clinical trial etc. In this case, certain examples transition from a “path guiding” or teaching mode to a “learning and observe” or learning mode to allow the clinicians to experiment and provide feedback to the improvement of future pathways and guidelines. Thus, certain examples strike a balance between encouraging compliance (by guiding) and fostering innovation (by learning). This helps to continuously improve pathways and prevent them from becoming stagnant, for example.

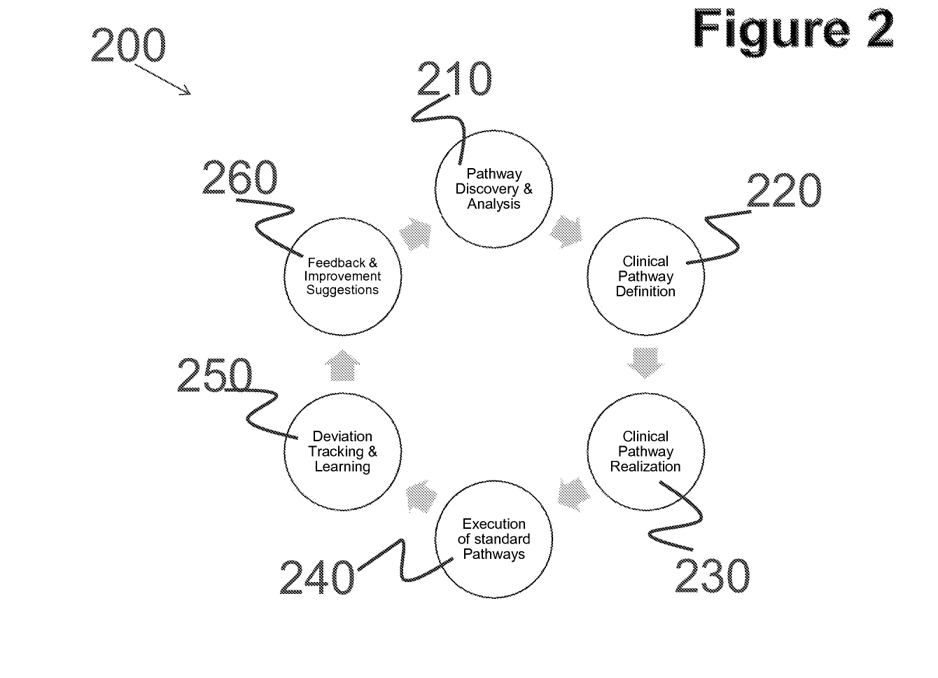

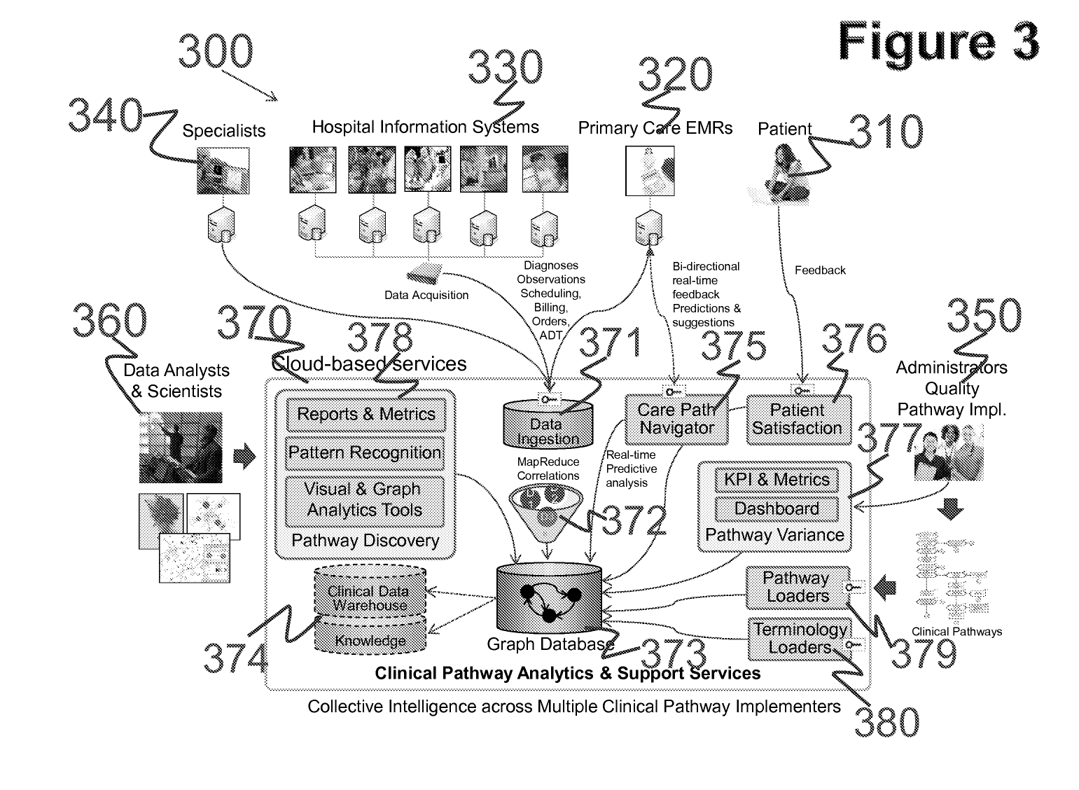

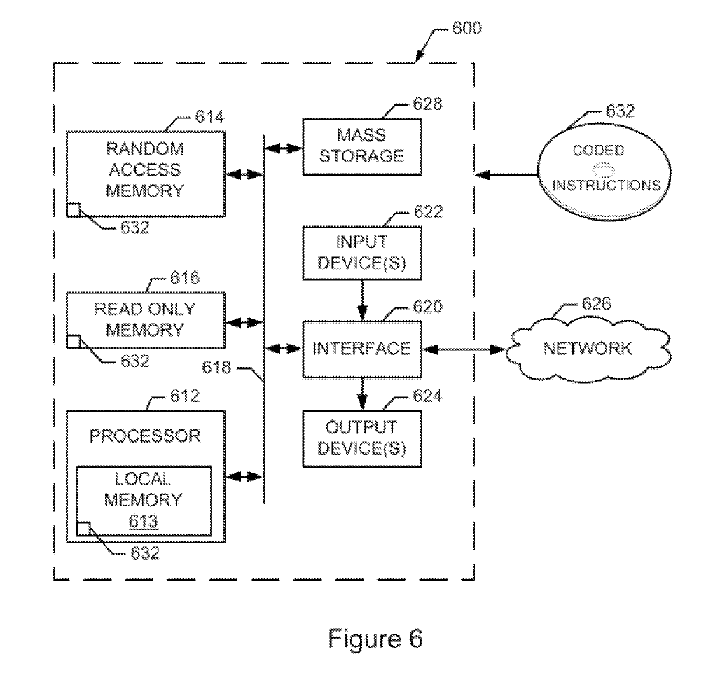

A flowchart representative of example machine readable instructions for implementing the example systems and methods described herein (e.g., of FIGS. 3-5) is shown in FIG. 2. In these examples, the machine readable instructions comprise a program for execution by a processor such as the processor 612 shown in the example processor platform 600 discussed below in connection with FIG. 6. The program may be embodied in software stored on a tangible computer readable medium such as a compact disc read-only memory (“CD-ROM”), a floppy disk, a hard drive, a digital video disc (DVD), Blu-ray disk, or a memory associated with the processor 612, but the entire program and/or parts thereof could alternatively be executed by a device other than the processor 612 and/or embodied in firmware or dedicated hardware. Further, although the example program is described with reference to the flowcharts illustrated in FIG. 2, many other methods of implementing the example systems, etc., may alternatively be used. For example, the order of execution of the blocks may be changed, and/or some of the blocks described may be changed, eliminated, or combined.

As mentioned above, the example processes of FIG. 2 may be implemented using coded instructions (e.g., computer readable instructions) stored on a tangible computer readable medium such as a hard disk drive, a flash memory, a read-only memory (“ROM”), a CD, a DVD, a Blu-Ray, a cache, a random-access memory (“RAM”) and/or any other storage media in which information is stored for any duration (e.g., for extended time periods, permanently, brief instances, for temporarily buffering, and/or for caching of the information). As used herein, the term tangible computer readable medium is expressly defined to include any type of computer readable storage and to exclude propagating signals. Additionally or alternatively, the example processes of FIG. 2 may be implemented using coded instructions (e.g., computer readable instructions) stored on a non-transitory computer readable medium such as a hard disk drive, a flash memory, a read-only memory, a compact disk, a digital versatile disk, a cache, a random-access memory and/or any other storage media in which information is stored for any duration (e.g., for extended time periods, permanently, brief instances, for temporarily buffering, and/or for caching of the information). As used herein, the term non-transitory computer readable medium is expressly defined to include any type of computer readable medium and to exclude propagating signals. As used herein, when the phrase “at least” is used as the transition term in a preamble of a claim, it is open-ended in the same manner as the term “comprising” is open ended. Thus, a claim using “at least” as the transition term in its preamble may include elements in addition to those expressly recited in the claim.

FIG. 2 depicts a flow diagram for an example method 200 for discovery and continuous improvement of clinical pathways.

At block 210, a discovery phase begins. The first phase represents a state before any standardization of clinical pathways has occurred. At this point, healthcare data is gathered (e.g., conforming to standards such as HL7, X12, etc.) and intelligence is provided regarding existing care paths. Self-serve analytics tools and business intelligence reports provide a first view to administrators at subscribing healthcare organizations, for example. Deeper analysis and training of machine algorithms are performed by data scientists and analysts, for example. The discovery phase facilitates analysis of existing paths, variances, patterns and trends for selected healthcare organizations and suggests evidence based clinical pathways and improvements.

At block 220, a clinical pathway definition phase begins. The definition of clinical pathways typically involve multidisciplinary work teams involving physicians (e.g., from family practitioners to specialists), nurses, therapists, social workers and administrators providing care in the selected area. At this phase, social graph and tools, for example, are provided to facilitate efficient collaboration in the working group. Key players and influencers in the social graph are determined based on usage data (e.g., from discover phase 210). Additionally, work of the team is guided by providing supporting facts, metrics and input to key Performance and outcome indicators, for example. Thus, a multidisciplinary team defines a project scope and targets evidence-based guidelines and pathways to realize. One or more reports are provided to guide the process.

At block 230, in an implementation phase, orders and workflows are created. For example, creation of standardized computerized physician order entry (CPOE) order sets and business process workflows is facilitated. Efficient implementation of clinical pathway practices involves the support of electronic healthcare records (EHRs), CPOE, clinical dashboards, etc. Furthermore, feedback services are provided which can be integrated into the clinician workflow (e.g., via embeddable physician portals, embeddable web parts, portlets, mobile applications, etc.). The feedback services support both the “teaching” mode and “learning” mode as described above.

At block 240, standard operating procedures are executed. For example, usage of standardized clinical pathways is tracked. Users can be coached or guided to comply. For example, after the clinical pathways have been institutionalized, usage is tracked and compliance is encouraged through nudging.

At block 250, deviation is tracked for learning. For example, when a care provider takes an “off-path” action, the path is tracked to enable the system to learn regarding the deviation. Thus, the teacher becomes the student. That is, a transition is made back into a “learning” mode in the case where a care provider deliberately deviates from an established pathway (e.g., after some initial gentle nudging to encourage compliance). This allows clinicians to provide feedback and rationale along the way.

At block 260, feedback is provided. For example, patients and providers can be surveyed to determine satisfaction of implemented pathways and gather improvement ideas.

FIG. 3 illustrates an example system 300 to provide collective intelligence across multiple clinical pathway implementers. The system 300 consumes healthcare data which may include HL7 order messages, Admit-Discharge-Transfer (ADT) instructions, scheduling information, X12 billing charges, observation messages, lab reports, progress notes, discharge information, referrals, etc. For privacy (e.g., HIPAA) reasons, any patient information may be de-identified. The system 300 is able to consume a wide variety of data sources and messages (some of which may be unstructured). The system 300 uses a “Data Ingestion” process or data ingestor 371 that can be implemented using, for example, in-memory analytics appliances (such as SAP HANA™, IBM Netezza™, Greenplum™, etc.) or Hadoop-based MapReduce™ implementations, etc. After the incoming data has been ingested 371, it is mapped and correlated by a correlator 372 into nodes and relationships (e.g., “vertices” and “edges”) and stored in a graph database 373. The core components are centered on the graph database 373, for example.

In certain examples, a graph database 373 is a specialized not only structured query language (SQL) or “NoSQL” database which excels at processing complex densely connected data (e.g., which traditional relational models may not be good at handling). Graph databases 373 (such as Neo4j™, InfiniteGraph™, AllegroGraph™, etc.) are adjusted or optimized for connections between data elements. A NoSQL database, for example, is a database management system that may or may not use SQL as its query language. Additionally, the database 373 may not require fixed table schemas and/or join operations, and can scale horizontally. A classic relational database can be a subset of a NoSQL database, for example.

Deeper and faster insight comes from the complexity of data. Index lookups and joins employed by relational databases may not scale for this problem set, for example. With graph database(s) 373, the transactional data and analytical data is the same. There is no need for separate online transaction processing (OLTP) and online analytical processing (OLAP) databases. This more easily enables real-time analytics on all data. The graph database 373 may also be used in conjunction with a traditional relational data warehouse 374 for outcome based analysis, for example.

Graph analytics is a powerful form of analytics that allows analysis of data in ways that are not possible with other analytics tools. For example, graph analytics can be used to find “hidden” relationships between organizations, diseases, causes, treatments, etc. Graph analytics tools (such as Cytoscape™) to visualize different care paths, simulate the most ideal paths and to uncover hidden relationships and dependencies.

Furthermore, programmable “graph miners” (e.g., algorithmic process) can be used to support a machine learning process. The “miners” can traverse the graphs to look for patterns, alert users of variances and perform data maintenance tasks, for example.

The system 300 includes a real-time Care Navigator 375 service to nudge or prompt clinicians into compliance or provide care providers with some actionable intelligence (e.g., similar to a GPS navigator in a car), for example. A Patient Satisfaction 376 service can survey patients that have been treated according to one or more clinical pathways to determine efficiency and satisfaction from a patient's perspective, for example.

Thus, in the example system 300, a patient 310 can provide feedback to the clinical pathways analytics and support services 370 (e.g., to the patient satisfaction service 376 of the analytics and support services 370). Additionally, one or more primary care electronic medical records (EMRs) 320 communicating with the analytics and support services 370 (e.g., the data ingestor 371, care path navigator 375, etc.) to provide bi-directional, real-time (or substantially real-time accounting for system processing/data access delay, etc.) feedback, predictions, suggestions, etc. Further, one or more hospital information systems 330, specialists 340, etc., can communicate with the analytics and support services 370 (e.g., the data ingestor 371) for data acquisition, diagnoses, observations, scheduling, billing, orders, ADT, etc.

Within the (e.g., cloud-based) clinical pathway analytics and support services 370, the correlator 372 maps, reduces, etc., data incoming via the data ingestor 371. Data is then stored in the graph database 373. Stored data can be combined with input from one or more of the care path navigator 375, patient satisfaction 376, etc., for real-time (or substantially real-time) predictive analysis.

Data in the graph database 373 can be augmented via pathway variance 377, pathway discovery 378, pathway loaders 379, terminology loaders 380, etc. For example, pathway discovery 378 can include one or more of reports and metrics, pattern recognition and visual and graph analytics tools to process and discover new clinical care pathways. One or more data analysts and scientists 360 can provide information for one or more clinical pathways to feed pattern recognition and analysis to identify or discover clinical pathway(s), for example. The pathway variance 377 can include one or more key performance indicators (KPIs) and metrics, dashboard, etc. One or more administrators can provide quality pathway implementation information 350 to the pathway variance 377 to identify variance in a defined clinical pathway, for example. Administrative implementation information can inform one or more clinical pathways provided via the pathway loader 379, for example.

Using available information, including collective intelligence across multiple clinical pathway implementers, a clinical data warehouse and knowledge base 374 can be updated from the graph database 373. Thus, variance and other feedback from a defined clinical pathway can be used to modify that definition and/or define a new (e.g., variant of) clinical pathway. Information sharing and analysis can be used to discovery and document new clinical pathway(s), for example. Via the cloud-based system, clinical pathway(s) and associated information can be shared for application, implementation, and further modification via a machine-learning feedback environment, for example.

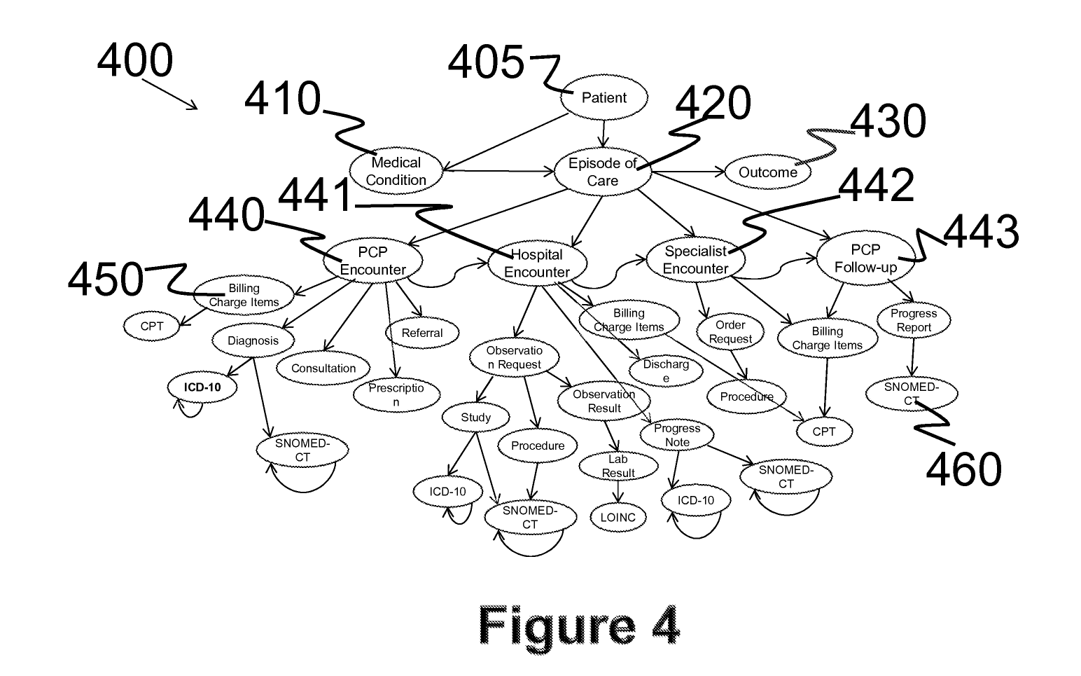

Certain examples utilize graph database technology to enable a variety of analytics. Graph databases provide more model flexibility compared to conventional relational databases. Graph databases can be schema-less and allow a set of nodes (e.g., object instances) with dynamic properties (e.g., corresponding to columns or attributes) to be arbitrary linked to other nodes through edges (e.g., associations). An example of a graph is shown on FIG. 4 which represents one instance of an “Episode of Care” 400. The example episode of care 400 includes a plurality of nodes and associations or relationships between nodes. Associations between nodes can also have attributes that further qualifies relationship(s) (such as cost, time, decision factors, scope, etc.).

For example, as shown in the graph 400, a patient 405 is associated with a medical condition 410 and an episode of care 420. The episode of care 420 is associated with an outcome 330. The episode of care 420 is also associated with one or more encounters such as a primary care physician (PCP) encounter 440, a hospital encounter 441, a specialist encounter 442, and a PCP follow-up 443. Each encounter 440-443 is associated with one or more items 450, such as charge items, referrals, order requests, reports, observation requests, observation results, procedures, discharges, notes, prescriptions, consultations, diagnosis, studies, labs, etc. Items 450 can be associated with one or more of the encounters 440-443, for example. Each item 450 can further be associated with a coding scheme, such as CPT, ICD-10, SNOMED-CT, LOINC, etc.

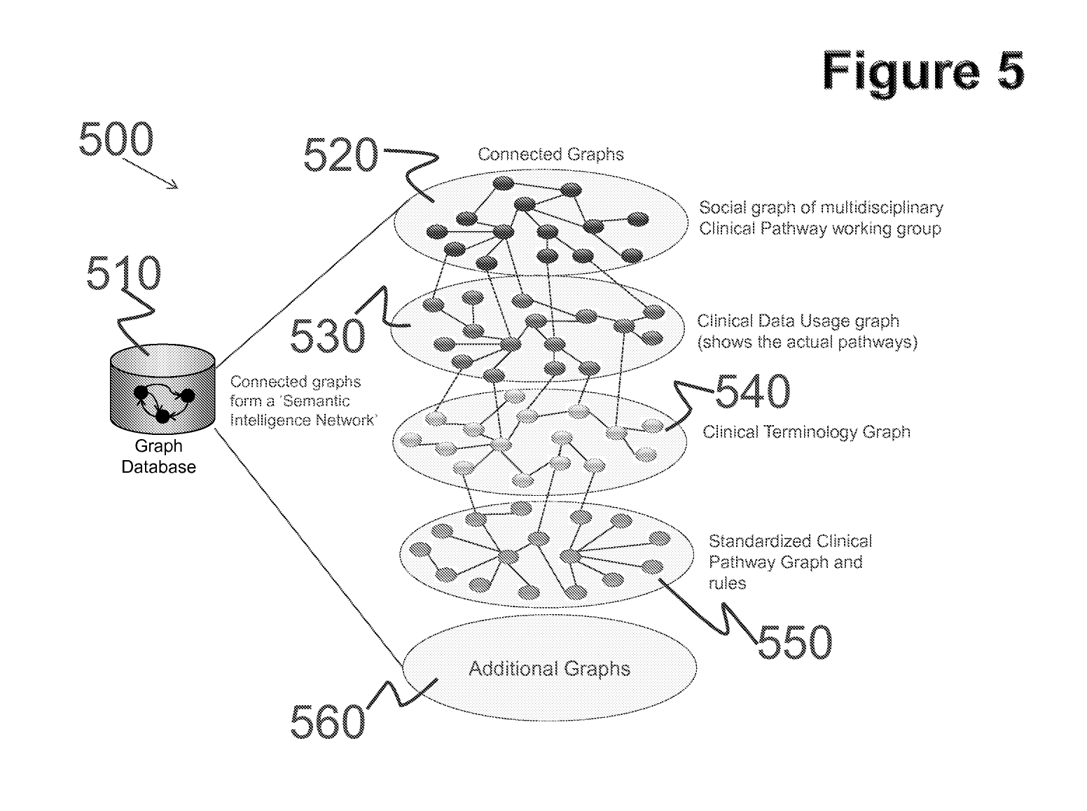

In certain examples, a data model includes multiple connected graphs, as shown, for example, in FIG. 5. For example, a plurality of connected graphs can form a semantic intelligence network in conjunction with a graph database 510 (e.g., such as the graph database 373 of FIG. 3). In the example of FIG. 5, a social graph 520 of a multidisciplinary clinical pathway working group is connected to a clinical data usage graph 530 showing usage of actual clinical pathways. The usage graph 530 is connected to a clinical terminology graph 540, which is in turn connected to a standardized clinical pathway graph and rules 550. This graph 550 can be connected to one or more additional graphs 560, for example.

Certain examples offer a new revenue stream for healthcare information technology and performance solutions by enabling adjacent online analytic services to clinical data warehouses in addition to consulting services for improvement of clinical and operational efficiency. Certain examples can be combined with one or more other healthcare product and solutions, such as clinical knowledge management and decision support systems, population health management systems, clinical data systems, enterprise information systems, Accountable Care Organization (ACO) solutions, Integrated Health Organizations (IHO), for example.

As depicted on FIG. 5, graph database technology can be leveraged to build up a semantic intelligence network around clinical pathways enabling superior analytics and machine learning capabilities. This intelligence is drawn from uncoordinated care data, managed care data, clinical pathways, outcome data, provider choices and deviations, patient satisfaction ratings, social and cultural preferences, etc.

In certain examples, a clinical research and analytics cloud including a plurality of analytics and repositories can be used to store, process, and dispense clinical data and associated analysis. Data in one or more repositories can be mined, shared, and/or otherwise used by the analytics and/or by an external user (e.g., an authorized user for identified data and/or a broader group of users for anonymous or de-identified data). In certain examples. data from the clinical research cloud can be shared with a cloud platform as a service (PaaS) via a knowledge base/clinical data warehouse (such as warehouse/knowledge base 374). Additionally, one or more patient- and/or physician-facing software as a service (SaaS) applications can be provided via the analytics and support service 370, for example.

Thus, certain examples provide and/or help facilitate a strong ecosystem of partners and key alliances, knowledge exchange clearinghouse services, etc., for early health and prevention. Certain examples enable a consumer to be involved and help initiate health prediction, planning, and management. Certain examples provide methods, apparatus, and systems for clinical pathways discovery, analysis, monitoring, and improvement (e.g., via machine learning) for improve detection and treatment of patient conditions. Certain examples provide both a focus on individual health challenges, as well as a comprehensive and integrated ecosystem.

In certain examples, the analytics and support services 370 can include and/or be in communication with one or more of a plurality of information systems 330, such as a radiology information system (RIS), a picture archiving and communication system (PACS), Computer Physician Order Entry (CPOE), an electronic medical record (EMR), Clinical Information System (CIS), Cardiovascular Information System (CVIS), Library Information System (LIS), and/or other healthcare information system (HIS), for example. An integrated user interface facilitating access to a patient record can include a context manager, such as a clinical context object workgroup (CCOW) context manager and/or other rules-based context manager. Components can communicate via wired and/or wireless connections on one or more processing units, such as computers, medical systems, smart phones, storage devices, custom processors, and/or other processing units. Components can be implemented separately and/or integrated in various forms in hardware, software and/or firmware, for example.

In certain examples, a patient record provides identification information, allergy and/or ailment information, history information, orders, medications, progress notes, flowsheets, labs, images, monitors, summary, administrative information, and/or other information, for example. The patient record can include a list of tasks for a healthcare practitioner and/or the patient, for example. The patient record can also identify a care provider and/or a location of the patient, for example.

In certain examples, an indication can be given of, for example, normal results, abnormal results, and/or critical results. For example, the indication can be graphical, such as an icon. The user can select the indicator to obtain more information. For example, the user can click on an icon to see details as to why a result was abnormal. In certain examples, the user may be able to view only certain types of results. For example, the user may only be eligible to and/or may only select to view critical results.

Certain examples address implementation and continuous improvement of the pathways as conditions change. Certain examples address concerns raised by critics to evidence based medicine such as “cookbook medicine”.

Certain examples also factors in social, cultural, and/or cross-institutional issues with pathway development including patient satisfaction. Additionally, certain examples focus on continuous machine learning, discovery, adoption and improvement of clinical pathways.

Certain examples attempts to overcome adoption challenges with clinical pathways. Certain examples automatically seek feedback from providers and patients, coaches when appropriate, and learns when clinicians decide to experiment/deviate from pathways. This fosters innovation, encourages adoption and continuously improves.

Certain examples build up a semantic intelligence network around clinical pathways enabling superior analytics and learning capabilities.

The above differentiators are enabled through end-to-end analytics of complex connected data sets. The underlying graph database technology and analytics is a technical enabler.

FIG. 6 is a block diagram of an example processor platform 600 capable of executing the instructions of FIG. 2 to implement the example system 300 of FIG. 3, the example graphs 400 and 500 of FIGS. 4 and 5, etc. The processor platform 600 can be, for example, a server, a personal computer, an Internet appliance, a set top box, or any other type of computing device.

The processor platform 600 of the instant example includes a processor 612. For example, the processor 612 can be implemented by one or more microprocessors or controllers from any desired family or manufacturer. The processor 612 includes a local memory 613 (e.g., a cache) and is in communication with a main memory including a volatile memory 614 and a non-volatile memory 616 via a bus 618. The volatile memory 614 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 616 may be implemented by flash memory and/or any other desired type of memory device. Access to the main memory 614, 616 is controlled by a memory controller.

The processor platform 600 also includes an interface circuit 620. The interface circuit 620 may be implemented by any type of interface standard, such as an Ethernet interface, a universal serial bus (USB), and/or a PCI express interface.

One or more input devices 622 are connected to the interface circuit 620. The input device(s) 622 permit a user to enter data and commands into the processor 612. The input device(s) can be implemented by, for example, a keyboard, a mouse, a touchscreen, a track-pad, a trackball, isopoint and/or a voice recognition system.

One or more output devices 624 are also connected to the interface circuit 620. The output devices 624 can be implemented, for example, by display devices (e.g., a liquid crystal display, a cathode ray tube display (CRT), etc.). The interface circuit 620, thus, typically includes a graphics driver card.

The interface circuit 620 also includes a communication device such as a modem or network interface card to facilitate exchange of data with external computers via a network 626 (e.g., an Ethernet connection, a digital subscriber line (DSL), a telephone line, coaxial cable, a cellular telephone system, etc.).

The processor platform 600 also includes one or more mass storage devices 628 for storing software and data. Examples of such mass storage devices 628 include floppy disk drives, hard drive disks, compact disk drives and digital versatile disk (DVD) drives. The mass storage device 628 may implement a local storage device.

The coded instructions 632 of FIGS. 2, 3, 4, and/or 5 may be stored in the mass storage device 628, in the volatile memory 614, in the non-volatile memory 616, and/or on a removable storage medium such as a CD or DVD.

Although certain example methods, systems, apparatus, and articles of manufacture have been described herein, the scope of coverage of this patent is not limited thereto. On the contrary, this patent covers all methods, systems and articles of manufacture fairly falling within the scope of the claims of this patent.

1. A computer-implemented method comprising:
gathering healthcare data and analyzing care paths currently in use by a healthcare organization, the analyzing including analyzing patterns and variances with respect to the care paths;
defining, using a processor, one or more evidence-based clinical pathways based on the gathered healthcare data and analyzed care paths in conjunction with practitioner review and supporting metrics;
facilitating implementation of the defined one or more evidence-based clinical pathways using computerized orders, computer-facilitated workflows and clinical dashboards;
tracking, using a processor, usage of the one or more evidence-based clinical pathways and providing reminders to users to encourage compliance;
monitoring deviations from the one or more evidence-based clinical pathways;
accepting feedback from at least one of patients and practitioners; and
analyzing deviations and feedback with respect to the one or more evidence-based clinical pathways to determine modification of the one or more evidence-based clinical pathways.

2. The method of claim 1, wherein gathered healthcare data comprises cost, efficiency and outcome.

3. The method of claim 1, wherein analyzing utilizes machine learning algorithms to analyze existing care paths, variances, patterns and trends for the healthcare organization.

4. The method of claim 3, further comprising sharing the machine learning algorithms and the one or more clinical pathways from the healthcare organization with a second healthcare organization.

5. The method of claim 1, wherein defining utilizes practitioner review from a multi-disciplinary team using one or more social graphs and usage data.

6. The method of claim 1, wherein the feedback is prompted from a practitioner based on a deviation from a clinical pathway.

7. The method of claim 1, further comprising storing data and clinical pathway information in a graph database for retrieval, review and analysis.

8. The method of claim 1, wherein the method is facilitated via computer-implemented, cloud-based clinical pathway analytics and support services.

9. A tangible computer-readable storage medium including a set of instructions to be executed by a processor, the instructions, when executed, implementing a method comprising:
gathering healthcare data and analyzing care paths currently in use by a healthcare organization, the analyzing including analyzing patterns and variances with respect to the care paths;
defining, using a processor, one or more evidence-based clinical pathways based on the gathered healthcare data and analyzed care paths in conjunction with practitioner review and supporting metrics;
facilitating implementation of the defined one or more evidence-based clinical pathways using computerized orders, computer-facilitated workflows and clinical dashboards;
tracking, using a processor, usage of the one or more evidence-based clinical pathways and providing reminders to users to encourage compliance;
monitoring deviations from the one or more evidence-based clinical pathways;
accepting feedback from at least one of patients and practitioners; and
analyzing deviations and feedback with respect to the one or more evidence-based clinical pathways to determine modification of the one or more evidence-based clinical pathways.

10. The computer-readable storage medium of claim 9, wherein gathered healthcare data comprises cost, efficiency and outcome.

11. The computer-readable storage medium of claim 9, wherein analyzing utilizes machine learning algorithms to analyze existing care paths, variances, patterns and trends for the healthcare organization.

12. The computer-readable storage medium of claim 11, wherein the machine learning algorithms predict outcome indicators for one or more clinical pathways and inform practitioners of implications associated with deviating from the one or more clinical pathways.

13. The computer-readable storage medium of claim 11, wherein the machine learning algorithms transition to a learning mode upon receiving feedback regarding a deviation from the one or more clinical pathways, the learning mode to retrain the machine learning algorithms.

14. The computer-readable storage medium of claim 9, wherein defining utilizes practitioner review from a multi-disciplinary team using one or more social graphs and usage data.

15. The computer-readable storage medium of claim 9, wherein the feedback is prompted from a practitioner based on a deviation from a clinical pathway.

16. The computer-readable storage medium of claim 9, further comprising storing data and clinical pathway information in a graph database for retrieval, review and analysis.

17. The computer-readable storage medium of claim 9, wherein the method is facilitated via computer-implemented, cloud-based clinical pathway analytics and support services.

18. A system comprising:
a data ingestor to gather healthcare data and analyze care paths currently in use by a healthcare organization, the data ingestor using a correlator to analyze patterns and variances with respect to the care paths;
a graph database to define, using a processor, one or more evidence-based clinical pathways based on the gathered healthcare data and analyzed care paths in conjunction with practitioner review and supporting metrics, the data ingestor and graph database to facilitate implementation of the defined one or more evidence-based clinical pathways using computerized orders, computer-facilitated workflows and clinical dashboards; and
a care path navigator to track usage of the one or more evidence-based clinical pathways and provide reminders to users to encourage compliance,
wherein the system is to monitor deviations from the one or more evidence-based clinical pathways, accept feedback from at least one of patients and practitioners, and analyze deviations and feedback with respect to the one or more evidence-based clinical pathways to determine modification of the one or more evidence-based clinical pathways.

19. The system of claim 18, further comprising machine learning algorithms to analyze existing care paths, variances, patterns and trends for the healthcare organization.

20. The system of claim 19, wherein the machine learning algorithms predict outcome indicators for one or more clinical pathways and inform practitioners of implications associated with deviating from the one or more clinical pathways.

21. The system of claim 19, wherein the machine learning algorithms transition to a learning mode upon receiving feedback regarding a deviation from the one or more clinical pathways, the learning mode to retrain the machine learning algorithms.

22. The system of claim 18, wherein a pathway discovery is to utilize practitioner review from a multi-disciplinary team using one or more social graphs and usage data and a pathway variance is to provide feedback from one or more healthcare organization administrators.

23. The system of claim 18, wherein the feedback is to be prompted from a practitioner based on a deviation from a clinical pathway.

24. The system of claim 18, further comprising a pathway loader and a terminology loader to provide clinical pathway information to the graph database, which provides updated clinical pathway information to a clinical data warehouse and knowledge base.

25. The system of claim 18, wherein the system is to be implemented at least in part based on computer-implemented, cloud-based clinical pathway analytics and support services.
